(19) United States
(12) Patent Application Publication
(10) Pub. No.: US 2005/0172143 A1
(43) Pub. Date: Aug. 4, 2005

(54) Method and apparatus for secure data storage

(76) Inventor: Daniel P. Fearnley, Stratford, CT (US)

Correspondence Address: PERMAN & GREEN, 425 POST ROAD, FAIRFIELD, CT, 06824, US

(21) Appl. No.: 10/768,815

(22) Filed: Jan. 30, 2004

(51) Int. Cl. H04L 9/32

(52) U.S. Cl. 713/194

(57) ABSTRACT

A data storage system includes a storage manager, a crypto engine, and a data store. The storage manager operates to present information to the crypto engine for providing encrypted information and further operates to present the encrypted information to the data store for storage.

### BACKGROUND OF THE INVENTION

1. Field of the Invention

The present invention relates to data storage and, more particularly, to storing data in an encrypted and secure manner.

2. Brief Description of Related Developments

Computer systems generally include one or more information or data storage systems which generally receive and store data for later use. As technology has advanced, the need for data storage has become increasingly important. It is also increasingly important that such data storage be secure so that data confidentiality is maintained.

### SUMMARY OF THE INVENTION

The disclosed embodiments provide a location to which data can be stored with protection from both viewing and tampering. While the disclosed embodiments are primarily intended for the storage of passwords, keys, or other sensitive security related items, it should be understood that the disclosed embodiments may be utilized for the storage of any type of data.

As such, the present invention is directed to a data storage system including a storage manager, a crypto engine, and a data store. The storage manager operates to present information to the crypto engine for providing encrypted information and further operates to present the encrypted information to the data store for storage. The storage manager may further operate to retrieve encrypted information from the data store, present the encrypted information to the crypto engine for providing unencrypted information, and to provide the unencrypted information to an application.

### BRIEF DESCRIPTION OF THE DRAWINGS

The foregoing aspects and other features of the present invention are explained in the following description, taken in connection with the accompanying drawings, wherein:

FIG. 1 is a block diagram of a data storage system incorporating features of the invention;

FIG. 2 is a diagram illustrating a scheme for assigning aliases to enable hierarchical navigation according to the invention;

FIG. 3 shows an exemplary configuration file which may be used by a Storage Manager navigation according to the invention;

FIG. 4 shows an exemplary configuration file which may be used by a Store navigation according to the invention; and

FIG. 5 shows an exemplary class diagram for components of a data storage system according to the invention.

### DETAILED DESCRIPTION OF THE EMBODIMENT(s)

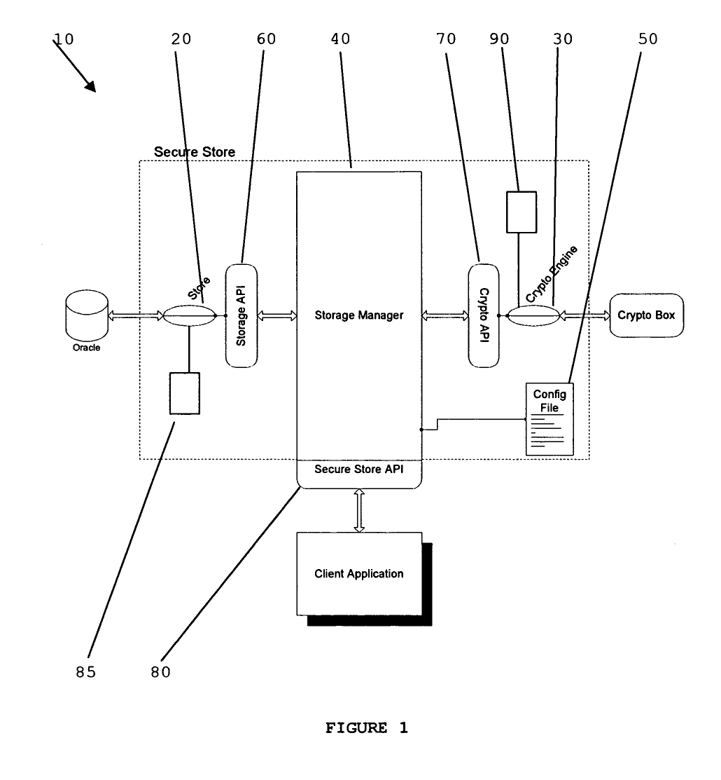

Referring to FIG. 1, a block diagram of a data storage system 10 incorporating features of the disclosed embodiments is illustrated. Although the embodiments disclosed will be described with reference to the embodiments shown in the drawings, it should be understood that the embodiments disclosed can be embodied in many alternate forms of embodiments. In addition, any suitable size, shape or type of elements or materials could be used.

As shown in FIG. 1, the data storage system 10 generally comprises a Store 20, a Crypto Engine 30, and a Storage Manager 40. In accordance with the invention, data is presented to Storage Manager 40, encrypted by Crypto Engine 30, and stored in Store 20.

It is feature of the invention that Store 20, Crypto Engine 30, and Storage Manager 40 are modular and constructed as separate applications. It is another feature of the invention that each component includes its own client interface. These aspects allow the components to be specified at runtime. Furthermore, this separation allows replacement of a particular component without modification to other components or client applications. To facilitate dynamic loading of the components, in one embodiment, the Store 20 and Crypto Engine 30 may be implemented as Java Beans while the Storage Manager 40 may be an application. However, any or all of the Storage Manger 40, Store 20, or Crypto Engine 30 may be implemented as a standalone application or as a Java Bean component written in the Java programming language.

As yet another feature of the invention, the components may be digitally signed for integrity protection of the data storage system 10 itself and of the data being stored. A utility may be provided for this purpose.

The Storage Manager 40 operates to service requests made through its interface from clients to either store or retrieve some specific data. The Store Manager also manages the operation of the Store 20 and Crypto Engine 30, and selects a particular Store 20 and Crypto Engine 30 for use with the system 10. The selection of which Store 20 and Crypto Engine 30 to employ may be performed at runtime. The selection may be made by the Storage Manager 40 based on a configuration file 50. The Store 20 or Crypto Engine 30 may also be verified prior to loading for use.

The Storage Manger 40 may provide a programmatic interface 80 for use by other applications as an alternative to a Graphical User Interface.

The Store 20 may be implemented as a Java Bean component in order to provide a flexible way of isolating the actual item storage functionality from the rest of the system. This may also allow for the replacement of the Store 20 without affecting the other components. The Store 20 generally provides storage of the data items submitted to it. All access to the Store 20 may be through an interface 60. The Store Manager 40 may use the interface to put items into and take items from the Store 20.

One embodiment of the Store 20 may utilize Oracle via JDBC as a storage mechanism. Such a design may facilitate Store replacement should the need arise. The location of the Store 20 may be supplied by the Storage Manager 40 and specified within the Store Manager's configuration file 50. The Store 20 may utilize a separate location from those used by other applications, such as Java applications, when present.

The Crypto Engine 30 may also be implemented as a Java Bean component in a modular to provide a flexible way of isolating the cryptographic functionality from the rest of the system. This may also enhance the ability to replace the Crypto Engine 30 without affecting the other components. The Crypto Engine 30 generally provides cryptographic processing functions to be performed against the data items, and may utilize standard, customized, or proprietary cryptographic practices. Generally, data items to be placed into a secure data store are first digitally signed and then encrypted. All access to the Crypto Engine 30 may be through an interface 70. The Store Manager 40 may use the interface 70 to request cryptographic functions from the Crypto Engine 30.

Access to the Crypto Engine 30 may be protected by a PIN. This PIN may enable the Storage Manager 40 to log into the Crypto Engine 30 for its use. The enforcement of PIN usage by the Crypto Engine 30 protects items in the data storage system 10 from access by non-authorized users because without access to the Crypto Engine 30 items in Store 20 can not be decrypted and are therefore unusable.

The Crypto Engine 30 may be implemented in hardware or software, including implementation of the storage of a master encryption key and the implementation of cryptographic algorithms.

Referring again to FIG. 1, data storage system 10 may be a standalone entity and may reside within its own JVM on any application server. It may be used by any and all applications, systems, or processes that may obtain access to it. This may include other standalone applications as well as servlets and EJBs. The data storage system 10 generally provides storage for sensitive data items such as cryptographic keys, passwords, logins, certificates, etc. Stored items may be identified using an alias which may follow a defined format, and items may be stored or retrieved individually or in bulk. The data storage system 10 may also provide a means to update data items individually by way of the alias for that item.

Every data item stored in the Store 20 may be identified by the alias. This alias may be a concatenation of identifiers to enable navigation of a hierarchical storage of the data. For example, the alias DPAG\FTP\UserName might specify a DPAG trunk with an FTP branch and a leaf of UserName.

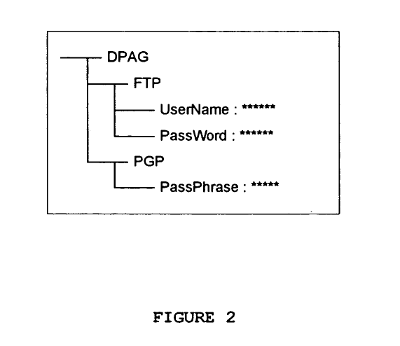

As shown in FIG. 2, with this approach a trunk may include one of more branches and a branch may include one or more branches. The leaf may be the location of the data and many leaves can populate a branch.

Note that the actual storage of data could vary based on the storage means supported by the specific Store 20 component used while the identification could remain the same.

As mentioned above, access to each of the Store 20, Crypto Engine 30 and Store Manager 40 is generally through each component's interface. The interface to the Storage Manager 40 may be a Secure Store Applications Programmer Interface (API) 80. The Secure Store API 80 may be used by client applications and may provide various applications or capabilities, for example, applications or capabilities to add an item to the data storage system 10, to retrieve an item from the data storage system 10, to delete an item from the data storage system 10, to request the Crypto Engine 30 to create one or more new keys for signing and encryption, to request the Crypto Engine 30 to create a new PIN for authorizing usage, etc.

A Store API 60 may be provided as part of the Store 20 to allow the Storage Manager 40 to insert, retrieve, and remove items to and from the Store 20. Additionally the Store API 60 may provide a means to query the Store 20 for information such as size and number of entries. The Store API 60 may also include methods, capabilities, or applications to add an item to the Store 20, to retrieve an item from the Store 20, to delete an item from the Store 20, to retrieve the number of items currently in the Store 20, to initialize a new Store 20, to empty the Store 20 of all items, to retrieve a collection of all items in the Store 20, to identify any returns encrypted without their corresponding alias, etc.

A Crypto API 70 may be provided as part of the Crypto Engine 30 to provide the Storage Manager 40 with the methods to have the cryptographic processes applied to the data items. Additionally, the Crypto API 70 may provide a means to perform administrative tasks on the component. The Crypto API 70 may include methods, capabilities or applications to request a digital signature, check a digital signature, encrypt data, decrypt data, request the Crypto Engine 30 to create one or more keys for signing and encryption, request the Crypto Engine 30 to mirror the keys to a second device, request a new PIN, retrieve the PIN, retrieve the PIN using a security phrase, add a security phrase for PIN retrieval, etc.

Each of the Store 20, Crypto Engine 30 and Store Manager 40 may use their own configuration files 85, 90, 50 respectively, which may operate to isolate the operations of the components, allow them to operate independently, and otherwise provide for a modular system design. The configuration files may be XML files. Additional configuration files may be used for specific implementations of the system components, for example, the Store 20 or the Crypto Engine 30.

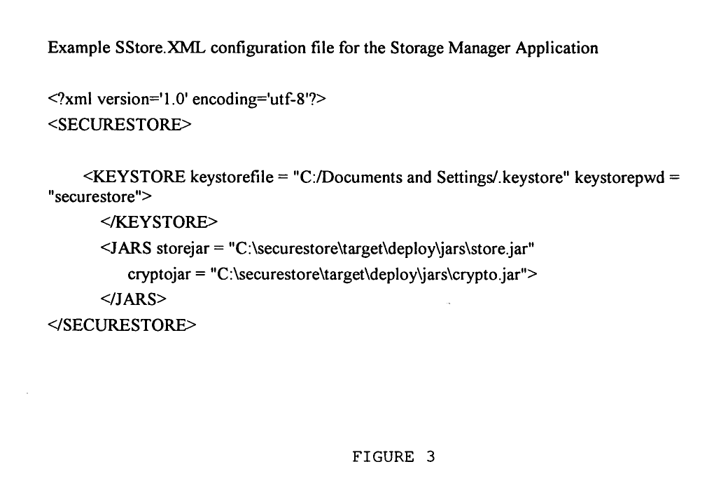

An exemplary configuration file which may be used by the Storage Manager 40 is shown in FIG. 3. The Storage Manager configuration file may be divided into main sections, for example, one for each secure data system component. Using an XML file as an example, a Storage Manager section may include tags whose values are applicable to the Storage Management component, a Store section may include tags whose values are applicable to the Store 20, and a Crypto Engine section may include tags whose values are applicable to the Crypto Engine 30. The Storage Manager configuration file may also include tags whose values are applicable to any Jar files which may hold Java Beans.

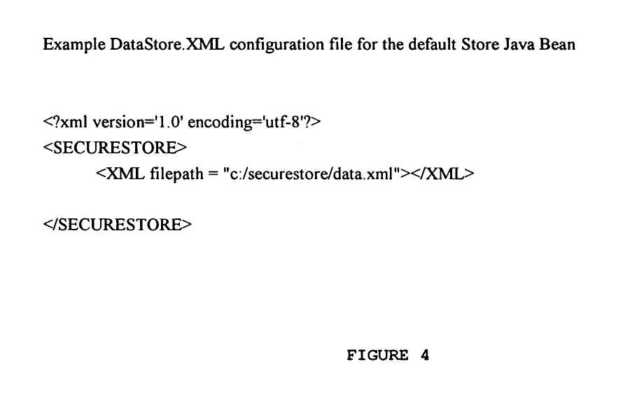

An exemplary configuration file which may be used by the Store 20 is shown in FIG. 4. The Store configuration file may include tags applicable to the Storage Manager 40 and tags that specify the location of the Store 20 itself.

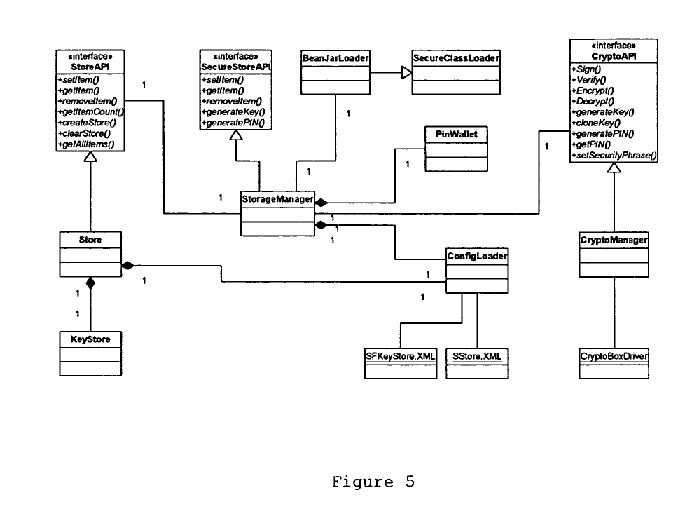

FIG. 5 shows an exemplary class diagram for the three components of the data storage system 10 for an example of the data storage system 10 where at least a portion of the system may be implemented in software.

The major classes that may be a part of this implementation are described below.

The StorageManager class is the main class of the Storage Manager 40. It is responsible for servicing the requests presented on the Secure Store API Interface. Additionally it is responsible for all management processes on the Crypto Engine 30 or the Store 20.

The BeanJarLoader class is an extension of the SecureClassLoader described below. It provides the Storage Manager 40 with digital signature verification of the signed Java Bean being loaded. It may only allow loading of Java Beans whose Jar file has been signed.

The SecureClassLoader class provides the dynamic loading for the Storage Manager 40 to instantiate the Java Beans implementing the Crypto Engine 30 and the Store 20. The SecureClassLoader class may be a J2SE supplied class.

The PinWallet class may be optional and may be a memory storage location for the Crypto Engine PIN required to submit requests.

The ConfigLoader class is responsible for reading configuration files which may be XML based and holding the information.

The CryptoEngineBean class is the Java Bean implementation for the Crypto Engine 30. It is responsible for publishing or providing the interface and managing the actual engine. In at least one embodiment, the Crypto Engine 30 may be implemented in hardware.

The Store class is the Java Bean implementation of the Store 20. It is responsible for providing the interface and managing the actual persistence mechanism. The Store 20 may be file based.

The KeyStore class provides file management for storing data.

While particular embodiments have been described, various alternatives, modifications, variations, improvements, and substantial equivalents that are or may be presently unforeseen may arise to Applicant's or others skilled in the in the art. Accordingly, the appended claims as filed, and as they may be amended, are intended to embrace all such alternatives, modifications, variations, improvements and substantial equivalents.

1. A data storage system comprising:
a storage manager;
a crypto engine; and
a data store, wherein the storage manager operates to present information to the crypto engine for providing encrypted information and further operates to present the encrypted information to the data store for storage.

2. The system of claim 1, wherein the storage manager further operates to retrieve encrypted information from the data store, and present the encrypted information to the crypto engine for providing unencrypted information.

3. The system of claim 1, further comprising:
an interface for providing an application with the ability to add an item to the system, delete an item from the system, and to retrieve an item from the system utilizing the storage manager.

4. The system of claim 1, further comprising:
a storage interface between the data store and the storage manager;
a crypto interface between the crypto engine and the storage maneger; and
a secure store interface between the storage manager and an application utilizing the data storage system.

5. The system of claim 1, wherein the storage manager, crypto engine, and data store are modular and constructed as separate applications.

6. The system of claim 1, wherein the storage manager, crypto engine, and data store are each components that are replaceable without modifying other system components.

7. The system of claim 1, wherein the crypto engine and data store are selectable by the storage manager.

8. A method of storing and retrieving data comprising:
presenting data to a crypto engine for providing encrypted data;
presenting the encrypted data to a data store for storage;
retrieving the encrypted data from the data store upon request; and
presenting the encrypted information to the crypto engine for providing the data in unencrypted form.

9. The method of claim 8, wherein the crypto engine and data store are modular and constructed as separate applications.

10. The method of claim 8, wherein the crypto engine and data store are each replaceable without modifying the other.
